(19) United States
(12) Patent Application Publication
(10) Pub. No.: US 2006/0141114 A1
(43) Pub. Date: Jun. 29, 2006

(54) Juice recovery process

(76) Inventors: Timothy Ralston Lang, New South Wales (AU); Rodney Trevor Zemanek, New South Wales (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/537,222

(22) PCT Filed: Aug. 28, 2003
(86) PCT No.: PCT/AU03/01110

§ 371 Date: Jan. 9, 2006

(30) Foreign Application Priority Data
Dec. 4, 2002 (AU) 2002953170

(51) Int. Cl. A23L 2/02

(52) U.S. Cl. 426/489

(57) ABSTRACT

Processes (200,300,500) and apparatus for processing plant material residue (141, 198, 530) remaining after primary juice has been extracted from the plant material are described. In one implementation the process (200) comprises using a diffusion extractor (205) to extract a liquid portion (211) from the plant material residue (141). The liquid portion (211) is then fractioned using a number of fractioning devices (225, 230, 245, 260, 272, 274) to produce secondary juice (275). The secondary juice (275) is then added to the primary juice.

### FIELD OF THE INVENTION

The present invention relates generally to processes for extracting material from plant material and, in particular, to the extracting of useful material from residue left after traditional juice extraction.

### BACKGROUND

Wine is an alcoholic beverage derived from grapes through fermentation, and has been enjoyed since the beginning of civilisation. More recently wine, and in particular red wine, has been touted as being responsible for the “French Paradox”—the low incidence of heart disease among the French people, even though they have a relatively high-fat diet. It is believed that resveratrol (trans-3,5,4′-trihydroxystilbene), which is contained in red wine, gives red wine certain pharmacological properties which contribute to the “French Paradox”. Resveratrol is also believed to be usable in the prevention or in the treatment of a number of human illnesses, such as diseases of the blood vessels, heart, and liver. While resveratrol is present in other plants, its most abundant natural source is the skins of red grapes.

FIG. 1 illustrates a typical prior art process 100 for producing red wine. The wine making process 100 may be divided into three general stages, namely a fermentation stage 101, a blending and maturation stage 102 and a packing and storage stage 103. Starting with the fermentation stage 101, after harvesting, the grapes 105 are crushed and destemmed by a crusher-destemmer 110. The crushing splits the skins and releases the juice, while the stemming removes the stems of the grapes 105 to avoid excessively high tannin levels in the wine. The stems make up about 2.9% per weight of the grapes 105.

With the stems removed from the grapes 105, the resulting crushed grape mixture 115, known as “must”, is pumped to a fermentor 130. Liquid tartaric acid 120 from a tartaric acid store 125 may be added to control the pH of the must 115.

Active yeast 135 is also added to the fermentor 130 to start primary fermentation of the must 115 therein. The red wine must 115 is allowed to ferment in the fermentor 130. The skins in the must 115 have a tendency to float to the top, and the floating skins is pushed back down into the mixture by the fermentor 130. Thus, the grape juice is fermented while in contact with the skins, thereby absorbing the red colour and flavours from the skins. During fermentation, the glucose sugar in the must 115 is broken down by the yeast 135 to form carbon dioxide and ethanol, which is the alcohol in wine. The carbon dioxide makes up about 10% per weight of the grapes 105.

Upon completion of the fermentation, or when the required amount of flavour and colour is absorbed from the skins, free-run wine 132 is removed through gravity separation from the fermentor 130 and placed in new wine storage 150. The free-run wine 132 makes up about 65% per weight of the grapes 105 added.

The remainder of the must in the fermentor 130 contains all of the skins and some wine. The combination is known as marc. To recover wine that cannot be obtained by gravity separation (ie. free-run wine 132), the marc 140 is fed to a press 145. The press 145 presses the marc 140 to produce press wine 148, which is also placed in new wine storage 150. The press wine 148 is high in flavour and colour pigments. The volume of press wine produced makes up about 7.1% per weight of the grapes 105 added. The remainder of the marc, referred to as pressed marc 141 is discarded.

From the new wine storage 150, the wine enters the blending and maturation stage 102, where the wine is blended and undergoes a number of storage, filtration and stabilisation phases to age the wine, remove particulate matter and improve clarity.

Finally, in the packing and storage stage 103, the wine is further blended, filtered, and bottled. Residue 152 and 153 from the filtration phases in the blending and maturation stage 102 and packing and storage stage 103 is discarded.

FIG. 2 illustrates a typical prior art process 160 for producing white wine. The process 160 for producing white wine is similar to that for producing red wine, except, because of the colour pigments found in the grape skins, the skins are removed early in the wine-making process 160 to control colouring of the wine in a fermentation stage 161. Accordingly, after the grapes 105 are crushed and stemmed by a crusher-stemmer 110, the must 115 is pumped to a drainer 165. The drainer 165 separates free-run juice 170 from marc 175 through gravity separation.

The free-run juice 170 is fed to a fermentor 190. The marc 175 is fed to the press 145. The press 145 presses the marc 175 to produce press juice 176, which is also placed in the fermentor 190, and white wine marc 198, which is discarded. Active yeast 195 is added to the juice 170 and 176 to start fermentation in the fermentor 190.

From the fermentor 190, once fermentation has completed, the resulting wine 197 enters the blending and maturation stage 102, followed by the packing and storage stage 103, similar to that described in relation to FIG. 1. Residue 154 and 155 from the filtration phases in the blending and maturation stage 102 and packing and storage stage 103 is discarded.

Referring again to the press 145 (FIGS. 1 and 2), with the press wine 148 (FIG. 1) removed from the red wine marc 140 (FIG. 1), or press juice 176 (FIG. 2) removed from the white wine mare 175 (FIG. 2), the pressed marc 141 (FIG. 1) or 198 (FIG. 2) still makes up about 15% per weight of the grapes 105 added. The pressed marc 141 and 198 may be stockpiled for re-use as fertiliser. However, the pressed marc 141 and 198 typically has to be stockpiled for about 12 months before application. This stockpiling causes problems including odour, water contamination, and is a breeding place for vermin, vinegar flies, etc.

An alternative use of the pressed marc 141 from red wine is as distilling material for production of wine spirits. Distillation of pressed marc 141 is typically done off-site from normal wine production, which requires a distilling company to collect large volumes of pressed marc 141 at great cost.

Further, the pressed marc 141 and 198 may be used as stockfeed or is simply disposed of to a landfill.

After the extraction of juice from other plant material, such as citrus fruit, there also remains a large volume of plant material. Such plant material is typically discarded or used as cattle feed.

### SUMMARY

The present inventors have determined that the disposal of the pressed marc 141 and 198 represents a significant waste of a resource from which valuable material can be extracted thereby recovering costs associated with creation of the resource and reducing costs associated with its disposal. Those costs are not only monetary, but also environmental. Further, the recovery of useful materials from such waste need not be limited to grapes and the wine industry, but to other foodstuffs including plant material, such as fruit and vegetables.

The present invention is thereby directed to optimising processing of such plant materials to extract and/or recover valuable materials that would otherwise be lost or discarded in traditional processes.

According to a first aspect of the present invention, there is provided a method of processing plant material residue remaining after primary juice has been extracted from the plant material. The method comprises the steps of:

extracting, using diffusion extraction, a liquid portion from the plant material residue;

fractioning secondary juice from the liquid portion; and

adding the secondary juice to the primary juice.

According to a second aspect of the present invention, there is provided an apparatus for processing plant material residue remaining after primary juice has been extracted from the plant material. The apparatus comprises:

a diffusion extractor for extracting a liquid portion from the plant material residue; and

at least one fractioning device for fractioning secondary juice from the liquid portion; wherein the secondary juice is added to the primary juice.

Other aspects of the invention are also disclosed.

### BRIEF DESCRIPTION OF THE DRAWINGS

Some aspects of the prior art and embodiments of the present invention will now be described with reference to the drawings, in which:

FIG. 1 illustrates a typical prior art process for producing red wine;

FIG. 2 illustrates a typical prior art process for producing white wine;

FIG. 3A illustrates a process for producing red wine in accordance with a first arrangement of the present disclosure;

FIG. 3B illustrates a wine recovery stage of FIG. 3A in more detail;

FIG. 4A illustrates a process for producing white wine in accordance with a second arrangement of the present disclosure;

FIG. 4B illustrates a juice recovery stage of FIG. 4A; and

FIG. 5 illustrates a process for extracting citrus juice.

### DETAILED DESCRIPTION

Where reference is made in any one or more of the accompanying drawings to features, which have the same reference numerals, those features have for the purposes of this description the same function(s), unless the contrary intention appears.

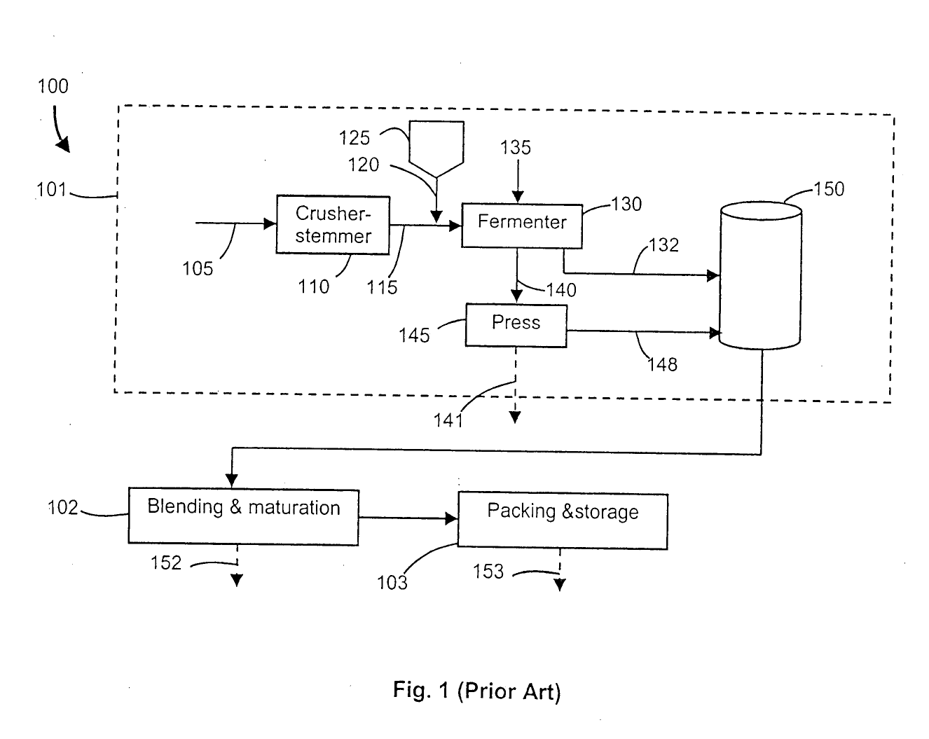

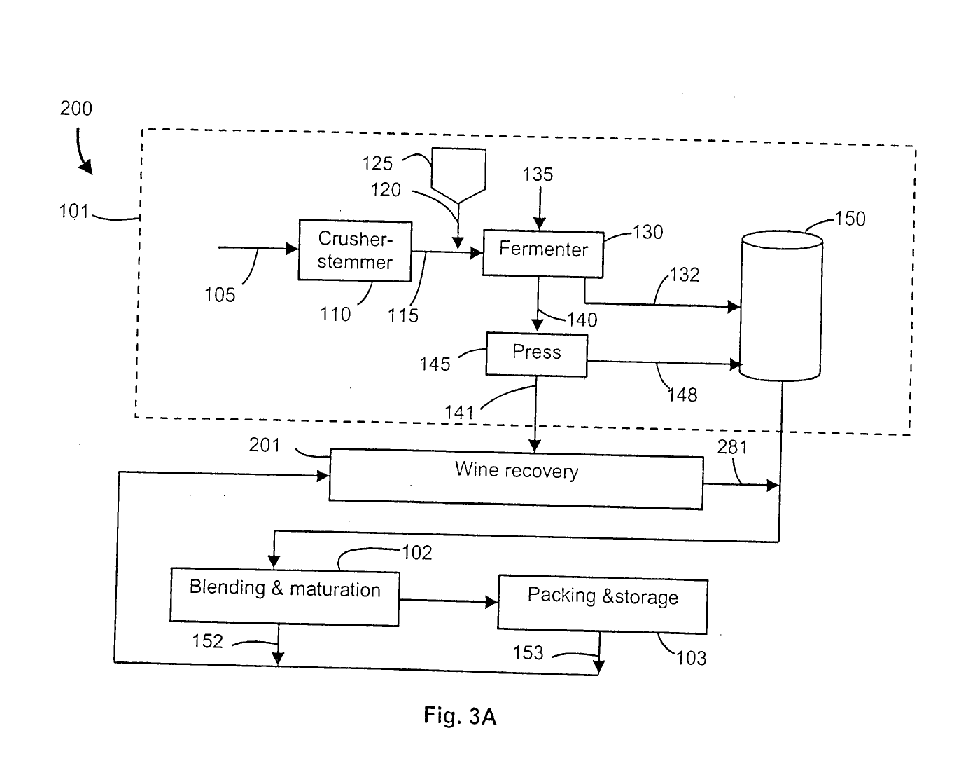

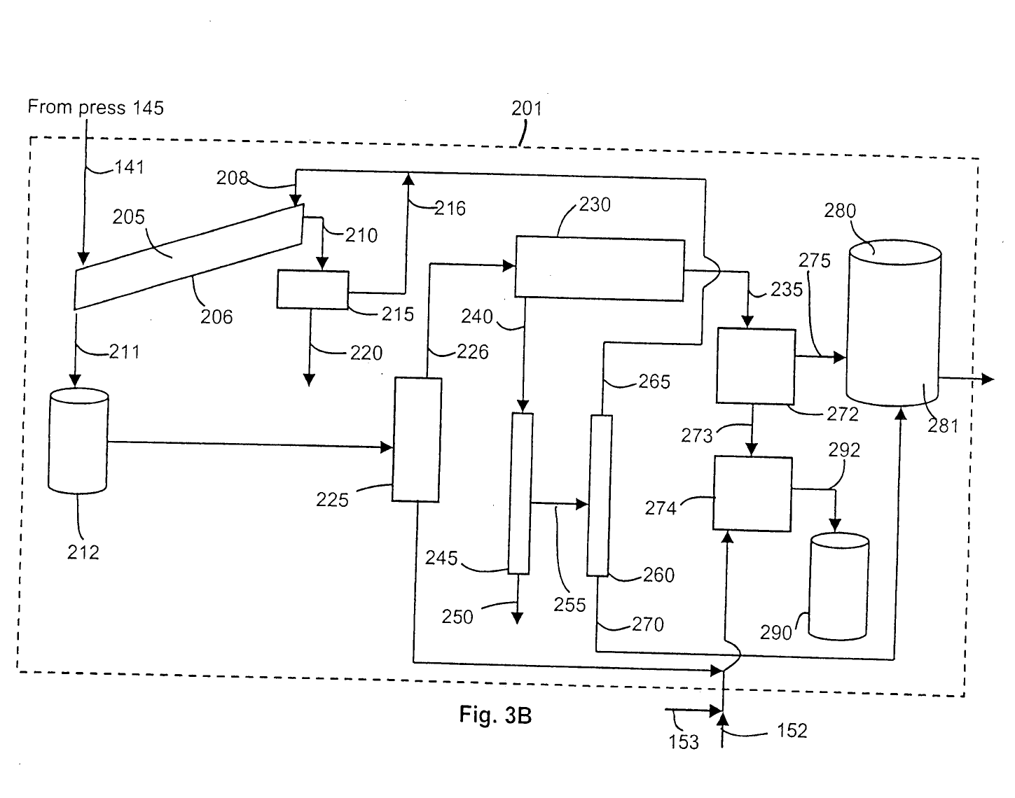

FIG. 3A illustrates a process 200 for producing red wine. The wine making process 200 comprises four general stages, namely a fermentation stage 101, a wine recovery stage 201, a blending and maturation stage 102 and a packing and storage stage 103. The fermentation stage 101, the blending and maturation stage 102 and the packing and storage stage 103 are the same as that described with reference to FIG. 1 in the “Background” section.

The wine recovery stage 201 receives as input the pressed marc 141 from the press 145 and produces recovered wine 281 therefrom. The recovered wine 281 is fed together with the wine in the new wine storage 150 to the blending and maturation stage 102 for further processing.

Preferably the wine recovery stage 201 also receives as input the residue 152 and 153 from the filtration phases in the blending and maturation stage 102 and packing and storage stage 103, for further processing.

FIG. 3B illustrates the wine recovery stage 201 in more detail. As noted with reference to FIG. 1, the pressed marc 141 makes up about 15% per weight of the grapes 105 added. The pressed marc 141 in process 201 is fed to a diffusion extractor, in the form of a counter current extractor 205, for extracting liquids, solubles, and fine particulate matter from the pressed marc 141.

The counter current extractor 205 comprises a screw conveyor (not illustrated) mounted within an inclined elongate housing 206, which takes the form of a trough or tube. An example of a counter current extractor is described in Australian Patent Publication No. 587994. The pressed marc 141 is fed into the lower end of the housing 206 and is carried upwards by the rotation of the screw conveyor. Water 208, which acts as an extracting liquid, is fed into the top of the housing 206. The preferred counter current extractor 205 reverses the direction of rotation of the screw conveyor intermittently. The screw conveyor is typically rotated at about 1 R.P.M.

The water 208 flows downwards under gravity, and penetrates the pressed marc 141. A liquid portion 211, which is water containing dissolved and dispersed extractable matter, is fed into a tank 212. A solid portion 210 which is carried to the top of the housing by the screw conveyor, is fed to a water recovery device 215 where water is removed from the solid portion 210 to produce water 216 and spent marc 220. The spent marc 220 makes up, on a dry weight basis, about 5.6% per weight of the grapes 105 added. The water recovery device 215 may be a press or an evaporator.

The water 216 recovered by the water recovery device 215 is added to the water 208 for recycling into the counter current extractor 205. The spent marc 220 mainly consist of plant fibres and may be used to produce mulch through composting or as cattle feed.

The liquid portion 211 in tank 212 is fed through a number of fractioning devices to recover useful components from the liquid portion 211. In the preferred implementation, the first fractioning device is a cross-flow filter 225, which removes particulate matter from the liquid portion 211 using micro-filtration. The cross-flow filter 225 avoids problems associated with the build-up the particulate matter on filter membranes by high tangential flow of the liquid portion 211 across the surface of the filter membranes. This allows the cross-flow filter 225 to be “self-cleaning”.

In the preferred implementation, filtered liquid 226 from the cross-flow filter 225 is fed to a second fractioning device in the form of a reverse osmosis device 230. The reverse osmosis device 230 pressurises the filtered liquid 226, and uses a membrane that is semi-permeable, allowing the water, alcohol and very small molecules to pass through the membrane, while rejecting larger molecules as residue 235.

Preferably the water, alcohol and very small molecule mixture 240 is fed to a third fractioning device in the form of a resveratrol recovery device 245. The resveratrol recovery device 245 is an absorption column using polymeric beads to extract from the mixture 240 various low molecular weight solubles 250, including resveratrol which is an anti-oxidant.

Liquid 255 from the resveratrol recovery device 245, which mainly comprises water and ethanol, is preferably fed to fourth fractioning device in the form of an alcohol/water splitter 260, such as a continuous feed still. The alcohol/water splitter 260 splits the liquid 255 to output water 265 and ethanol 270. The water 265 is added to the water 208 for recycling into the counter current extractor 205, while the ethanol 270 is fed to recovered wine storage 280.

Hence, the water 208 supplied to the counter current extractor 205 is recycled/recovered “wine” water, thereby reducing the water usage of the winery, while at the same time reducing wastewater.

Referring again to the reverse osmosis device 230, the residue 235 is preferably fed to a crystallisation device 272. The crystallisation device 272 removes potassium hydrogen tartrate 273 (also known as cream of tartar), which is a crystalline sediment within the residue 235, from the residue 235. The recovered potassium hydrogen tartrate 273 makes up about 0.8% per weight of the grapes 105 added.

The remainder of the residue 275 is also fed to the recovered wine storage 280 where it is mixed with the ethanol 270 from the alcohol/water splitter 260. The recovered wine storage 280 now contains recovered wine 281. The recovered wine 281 makes up about 8.6% per weight of the grapes 105 added and is disproportionably high in flavour and colour pigments.

The potassium hydrogen tartrate 273 from the crystallisation device 272 and the residue 152 and 153 from the filtration phases in the blending and maturation stage 102 and packing and storage stage 103 respectively are fed to a tartaric acid production device 274 where tartaric acid 292 is produced. The tartaric acid 292 is stored in a liquid tartaric acid store 290. The device 274 typically uses a small input of sulphuric acid.

The liquid tartaric acid in the liquid tartaric acid store 290 is used to fill the liquid tartaric acid store 125. Hence, the winery produces its own tartaric acid rather than having to purchase the tartaric acid from external sources. Surplus tartaric acid may be sold.

As noted above with reference to FIG. 3A, the recovered wine 281 from the recovered wine storage 280 is fed together with the wine in the new wine storage 150 to the blending and maturation stage 102. With the addition of the recovered wine 281, the wine yield is increased from about 72.1% in the arrangement of FIG. 1, to about 80.7% per weight of the grapes 105 added, which equates to a 12% increase in wine yield. Furthermore, the coherence of the wine is maintained, as the recovered wine 281 and the wine in the new wine storage 150 come from the same batch of grapes 105.

In an alternative implementation (not illustrated) the marc 140 from the fermentor 130 can be directly fed to the counter current extractor 205, thereby eliminating a step, that is the need for the press 145, in the wine production process 200. The pressed wine 148 is not lost, as it is recovered by the wine recovery stage 201.

One further advantage of the wine production process 200 is that the must I 15 may be removed earlier from the fermentor 130, as the wine recovery stage 201 will extract colour pigments and flavour from the marc 141 and reintroduce the colour pigments and colour to the wine when the recovered wine 281 is mixed with the wine in the new wine storage 150. By removing the must from the fermentor 130 earlier, the fermentor 130 is freed up for processing a next batch.

On completion of a batch, the water 208 may be used to rinse all tanks and apparatus in the process 200. The residue from the rinsing may be fed to the crystallisation device 272 for production of further potassium hydrogen tartrate.

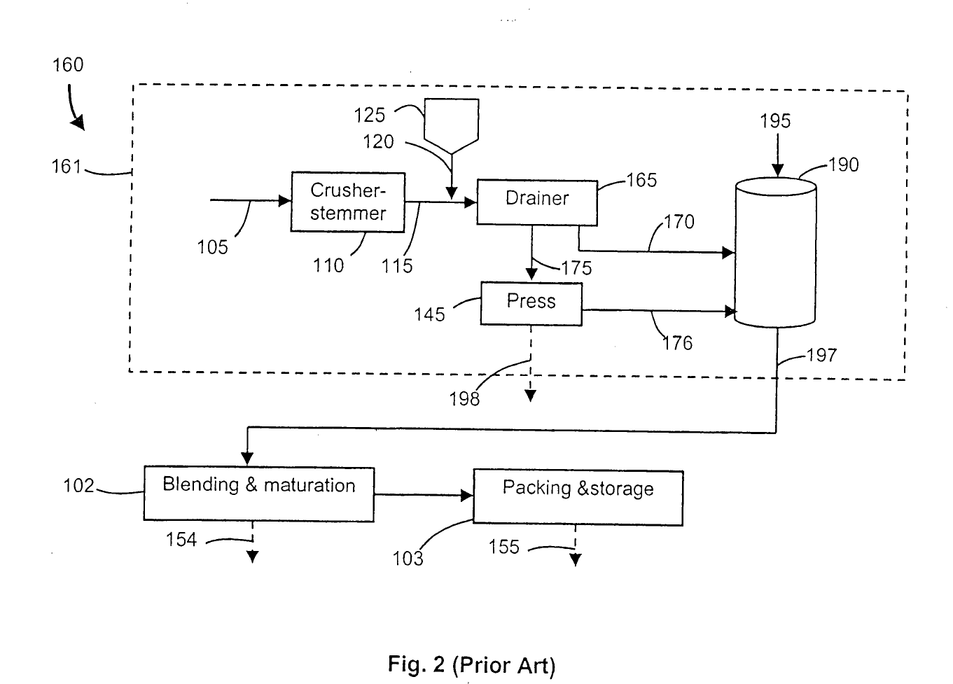

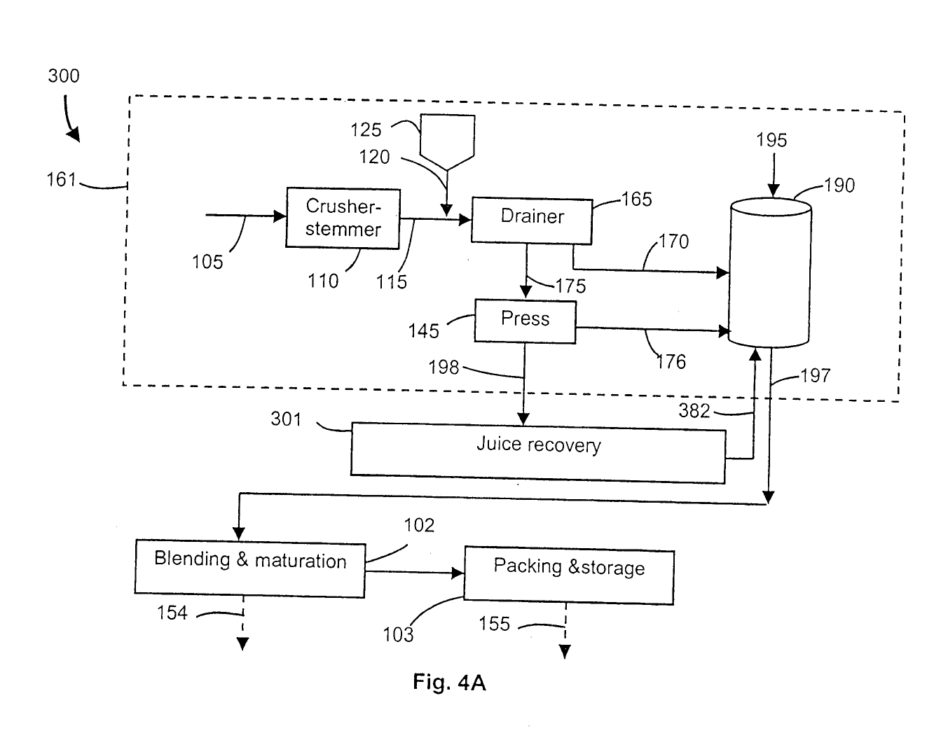

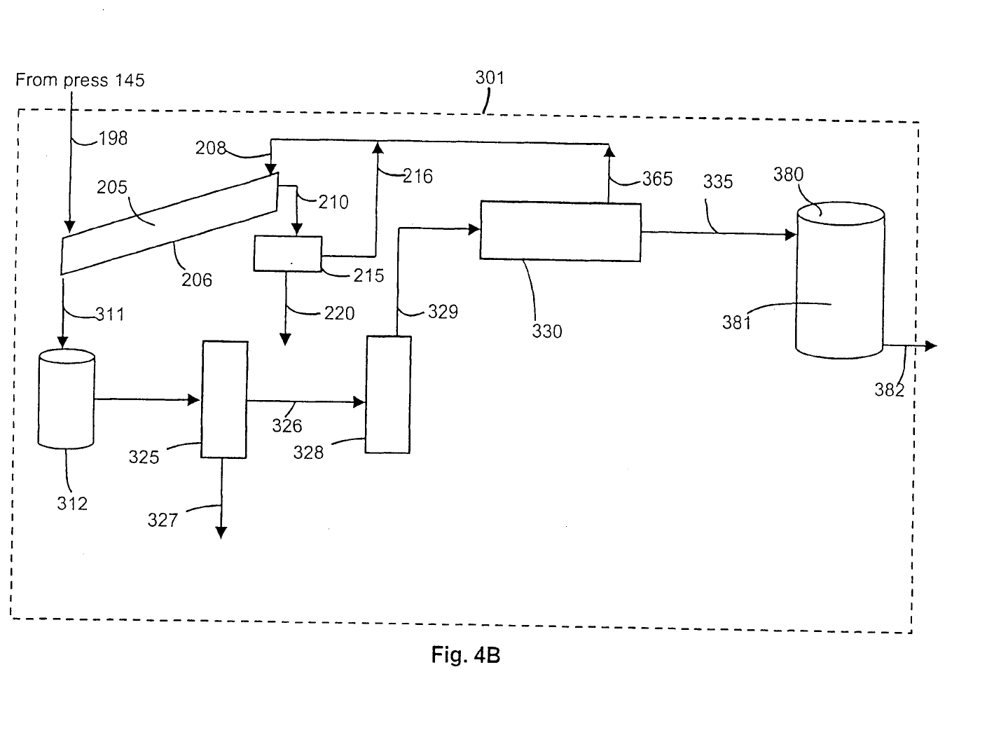

The principles used in the process 200 may also be applied in the production of white wine. In FIG. 4A, a white wine making process 300 also comprises four general stages, namely a fermentation stage 161, a juice recovery stage 301, a blending and maturation stage 102 and a packing and storage stage 103. The fermentation stage 161, the blending and maturation stage 102 and the packing and storage stage 103 are the same as those described with reference to FIG. 2 in the “background” section.

The juice recovery stage 301 receives as input the white wine marc 198 from the press 145 and produces recovered juice 382 therefrom. The recovered juice 382 is also fed to the fermentor 190. The fermentor 190 thus contains the free-run juice 170, the press juice 176 and the recovered juice 382, all of which is fermented to produce wine 197.

FIG. 4B illustrates the juice recovery stage 301 in more detail. The pressed white wine marc 198 is fed to a counter current extractor 205 and water recovery device 215 combination, for extracting Liquids, solubles, and fine particulate matter from the pressed marc 198, to produce a liquid portion 311, spent marc 220 and recovered water 216. The liquid portion 311, which is water containing dissolved and dispersed extractable matter, is fed into a tank 312.

The liquid portion 311 in tank 312 is fed through a number of fractioning devices to recover useful components from the liquid portion 311. In the preferred implementation the first fractioning device is a cross-flow filter 325, which removes suspended solid material 327 from the Liquid portion 311 using micro-filtration.

In the preferred implementation, filtered liquid 326 from the cross-flow filter 325 is fed to a second fractioning device in the form of a ultra-filtration device 328 for further clarifying the filtered liquid 326. For example, a controlled amount of the colour pigments (phenolics) may be removed.

In the preferred implementation, the liquid 329 from the ultra-filtration device 328 is then fed to a third fractioning device in the form of a reverse osmosis device 330. The reverse osmosis device 330 allows water 365 to pass through membranes, while rejecting larger molecules as residue 335.

The water 365 is added to the water 208 for recycling into the counter current extractor 205, while the residue 335, which mainly comprises concentrated juice, is fed to a recovered juice tank 380. The recovered juice tank 380 now contains recovered juice 381. As described above, the recovered juice 381 is fed to the fermentor 190 (FIG. 4A) where the recovered juice 381 is combined with the free-run juice 170 and the press juice 176.

Again, the coherence of the juice is maintained, as the wine 197 in the fermentor 190 come from the same batch of grapes 105.

In an alternative implementation (not illustrated) the marc 175 from the drainer 165 is directly fed to the counter current extractor 205, thereby eliminating a step in the wine production process 300. The pressed juice 176 is not lost, as it is recovered by the juice recovery stage 301.

Hence, from the above it can be seen that the wine production processes 200 and 300 are “holistic”. Many of the input chemicals are manufactured by the processes themselves, such as the tartaric acid. Also, by recycling of the water (wine-water) in the wine recovery stage 201 and juice recovery stage 301, not only is the water usage reduced, the effluent is also reduced. Below is a table setting out, in percentages by weight, the elements typically produced by the processes 200 and 300.

TABLE 1

| Element | % by weight |
|---|---|
| Free run wine | 65 |
| Press wine | 7.1 |
| Recovered wine | 8.6 |
| Dry marc solids | 5.6 |
| Potassium Hydrogen Tartrate | 0.8 |
| CO₂ | 10 |
| Dry stems | 2.9 |

Importantly, the yield of wine produced is 80.7%, compared to 72.1% in prior art processes 100 and 160, which is a 12% increase in yield.

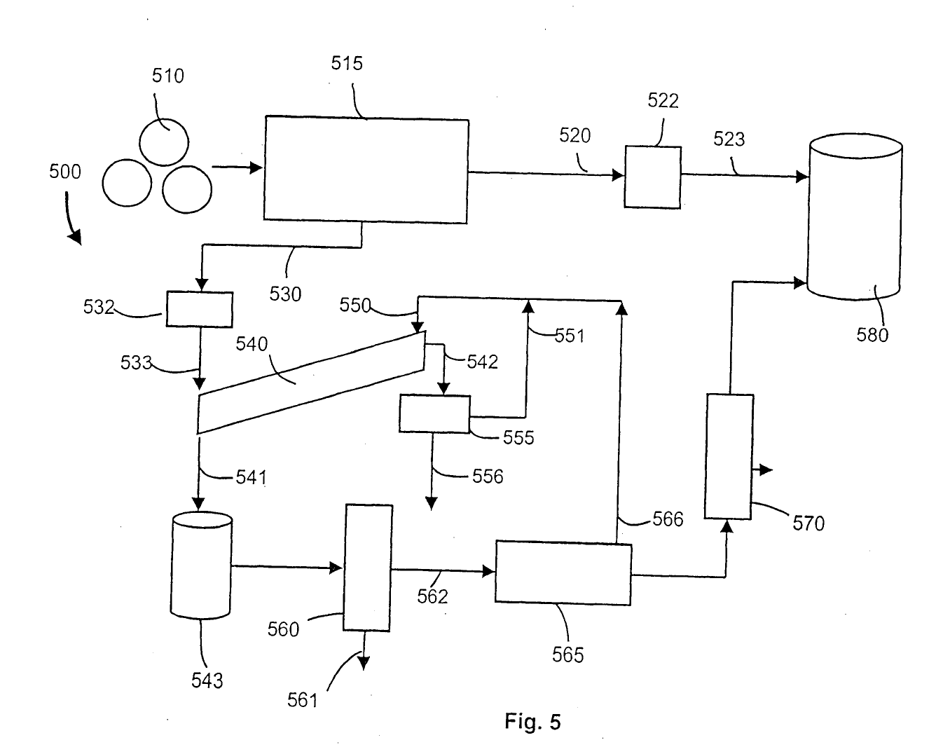

Processes 200 and 300 relate to the production of wine. However, the principles described herein have general applicability to any plant material residue left after juice extraction, including that from tomatoes, oranges, apples etc. To illustrate this, FIG. 5 illustrates a process 500 for extracting juice from citrus fruit 510. The tissues of citrus fruit 510 may be broadly classified into endocarp, peel and seed tissues. The citrus fruit 510 is first put through a primary juice extraction device 515 to produce primary juice 520 and residue material 530. The primary juice 520 is fed through a fisher 522 where seeds and other heavy solids are removed from the primary juice 520, before the finished primary juice 523 is pumped to a juice tank 580.

In one implementation, the primary juice extraction device 515 operates by halving the citrus fruit 510 and reaming the primary juice 520 from the endocarp. In another implementation, the primary juice extraction device 515 operates by coring the citrus fruit 510 and squeezing the primary juice 520 from the endocarp through a coring device.

The primary juice 520 typically contains fruit sugars, citric acid, minerals, vitamins including ascorbic acid (vitamin C), a range of desirable bio-active compounds, including flavonoids and some limonoids, and undesirable bitter compounds. Citrus fruit peel typically contains the same compounds, but is disproportionately high in desirable bioactive compounds in sugars and minerals, and disproportionately low in citric acid.

The residue material 530 mainly contains citrus fruit peel. The residue material 530 is fed to a slicing device 532 where the citrus fruit peel is sliced into small pieces. The sliced residue 533 is fed to a counter current extractor 540, for extracting liquids, solubles, and fine particulate matter from the residue 533.

The sliced residue 533 is fed into the lower end of the counter current extractor 540, while water 550 is fed into the top of the counter current extractor 540. The water 550 flows downwards under gravity, and penetrates the residue 533. A liquid portion 541 is retrieved from the lower end of the counter current extractor 540 and fed into a tank 543.

A solid portion 542, which is expelled from the top of the counter current extractor 540, is fed to a water recovery device 555 where water is removed from the solid portion 542 to produce water 551 and mainly dried peel 556. The dried peel 556 is removed and may be composted, used as cattle feed, or used as a component of a supplement for human nutrition, as is described in Australian Patent Publication No. 0736545. The water 551 recovered by the water recovery device 555 is added to the water 550 for recycling into the counter current extractor 540.

The liquid portion 541 in tank 543 is fed through a number of fractioning devices for clarification. In the preferred implementation, the first fractioning device is a cross-flow filter 560, which removes suspended insoluble solids 561 from the liquid portion 541 using micro-filtration.

In the preferred implementation, filtered liquid 562 from the cross-flow filter 560 is next fed to a second fractioning device in the form of a reverse osmosis device 565. The reverse osmosis device 565 removes water 566 from the filtered liquid 562 to produce a clarified concentrated liquid 568. The water 566 is added to the water 550 for recycling into the counter current extractor 540.

Preferably the clarified concentrated liquid 568 is fed to a third fractioning device in the form of an absorption column 570, containing polymeric beads, for removing from the clarified concentrated liquid 568 undesirable bitter compounds and some of the desirable bioactive compounds.

The liquid 575 from the absorption column 570 is recovered citrus fruit juice, which is added to the finished primary juice 523 in the juice tank 580.

In another implementation the liquid 575 is put through a further fractioning device (not illustrated) in the form of iron exchange resins and crystallisation devices for removing calcium, calcium ascorbate and calcium citrate. The liquid obtained from the further fractioning device, together with the calcium ascorbate and calcium citrate, are then added to the finished primary juice 523 in the juice tank 580.

The yield of finished primary juice 523 is 55-60% by weight of the citrus fruit 510 used. This is the only juice extracted by prior art processes. Process 500 extract an additional 25-30% by weight of the citrus fruit 510 used as recovered citrus fruit juice 575, thus a 40% increase in yield. An additional benefit of process 500 is that the concentrations of Polymethoxylated Flavones and Limonoid Glucosides (desirable bioactives) in the resulting citrus fruit juice is double that in the finished primary juice 523 alone

The foregoing describes only some embodiments of the present invention, and modifications and/or changes can be made thereto without departing from the scope and spirit of the invention, the embodiments being illustrative and not restrictive. For example, further fractioning devices may be added to extract further components from the plant material.

1. A method of processing plant material residue remaining after primary juice has been extracted from the plant material, said method comprising the steps of:
extracting, using diffusion extraction, a liquid portion from said plant material residue;
fractioning secondary juice from said liquid portion; and
adding said secondary juice from said primary juice.

2. A method according to claim 1, wherein said diffusion extraction uses water as an extraction liquid, said method comprising the further steps of:
recovering liquid from a solid portion remaining after said liquid portion is extracted; and
recycling said recovered liquid as said extraction liquid.

3. A method according to claim 2, wherein said recovered liquid is substantially water.

4. A method according to claim 1, wherein said fractioning step removes at least water from said liquid portion to obtain said secondary juice.

5. A method according to claim 4, said method comprising the further step of recycling said water removed from said liquid portion as said extraction liquid.

6. A method according to claim 1, wherein said plant material residue is fermented and said fractioning step removes a water and alcohol mixture from said liquid portion to obtain said secondary juice, said method comprising the further step of splitting said water and alcohol mixture into at least alcohol and water.

7. A method according to claim 6, wherein said plant material residue is from red wine grapes and said fractioning step further comprises removing at least resveratrol from said juice portion.

8. A method according to claim 5, said method comprising the further step of adding said alcohol to said secondary juice.

9. A method according to claim 5, said method comprising the further step of recycling said water removed from said liquid portion as said extraction liquid.

10. A method according to claim 5, wherein said fractioning step further comprises recovering tartrates from said liquid portion.

11. An apparatus for processing plant material residue remaining after primary juice has been extracted from the plant material, said apparatus comprising:
diffusion extractor for extracting a liquid portion from said plant material residue; and
at least one fractioning device for fractioning secondary juice from said liquid portion; wherein said secondary juice is added to said primary juice.

12. An apparatus according to claim 11, wherein said diffusion extractor uses water as an extraction liquid, said apparatus further comprising:
recovery device for recovering liquid from a solid portion remaining after said liquid portion is extracted, wherein said recovered liquid is recycled as said extraction liquid.

13. An apparatus according to claim 12, wherein said recovered liquid is substantially water.

14. An apparatus according to claim 11, wherein said at least one fractioning device removes at least water from said liquid portion to obtain said secondary juice.

15. An apparatus according to claim 14, wherein said water removed by said fractioning device is recycled as said extraction liquid.

16. An apparatus according to claim 11, wherein said plant material residue is fermented and said at least one fractioning device comprises:
a reverse osmosis device for removing a water and alcohol mixture from said liquid portion to obtain said secondary juice; and
an alcohol/water splitter for splitting said water and alcohol mixture into at least alcohol and water.

17. An apparatus according to claim 16, wherein said plant material residue is from red wine grapes and said at least one fractioning device further comprises:
a resveratrol recovery device for removing at least resveratrol from said juice portion.

18. An apparatus to claim 15, wherein said alcohol is added to said secondary juice.

19. An apparatus according to claim 15, wherein said water removed from said liquid portion is recycled as said extraction liquid.

20. An apparatus according to claim 15, wherein said at least one fractioning device further comprises:
a crystallization device for recovering tartrates from said liquid portion.
